(19) United States
(12) Patent Application Publication
(10) Pub. No.: US 2007/0235234 A1
(43) Pub. Date: Oct. 11, 2007

(54) Wheelchair and Carrying Wheel Provided with a Wheel Motor for Use in Such a Wheelchair

(75) Inventor: Wilhelmus Petrus Johannes De Kruijf, Enschede (NL)

Correspondence Address: THE WEBB LAW FIRM, P.C., 700 KOPPERS BUILDING, 436 SEVENTH AVENUE, PITTSBURGH, PA, 15219, US

(73) Assignee: INDES HOLDING B.V., Enschede (NL)

(21) Appl. No.: 10/594,042

(22) PCT Filed: Mar. 24, 2005
(86) PCT No.: PCT/NL05/00223

§ 371 Date: May 11, 2007

(30) Foreign Application Priority Data
Mar. 25, 2004 (NL) 1025807

(51) Int. Cl. A61G 5/04

(52) U.S. Cl. 180/65.2; 310/67 R

(57) ABSTRACT

The invention relates to a wheelchair, containing: a frame, at least two carrying wheels, whereby each carrying wheel by means of an insertable axle is detachably connected to the frame, and at least one electrical wheel motor for electrical drive of the carrying wheels, whereby the wheel motor is fitted at least partly in a wheel hub of a carrying wheel. The invention also relates to a carrying wheel provided with a wheel motor for use in such a wheelchair.

The invention relates to a wheelchair, containing: a frame, at least two carrying wheels, whereby each carrying wheel is detachably connected to the frame by means of an insertable axle, and at least one electrical wheel motor for the electrical drive of the carrying wheels, whereby the wheel motor forms part of the detachable carrying wheel. The invention also relates to a carrying wheel provided with a wheel motor for use in such a wheelchair.

The wheelchair mentioned in the preamble has been in existence for several years. For example, such a wheelchair is described in the European patent EP 0 528 235 in the name of ‘Haas & Alber Haustechnik und Apparatebau GmbH’ (Alber). The wheelchair described in the Alber patent contains a frame provided with several carrying wheels, whereby a DC motor is included in a wheel hub of each carrying wheel for the drive of the carrying wheels. Here, the DC motor is provided with a transmission. Each carrying wheel is provided with an insertable axle, with the help of which the carrying wheel is detachably connected to the frame. The stator of each DC motor is detachably fixed to the frame via a support part, in particular to a case that is part of the frame. The advantage of such an electrical wheelchair is that the wheelchair can be relatively quickly and easily assembled and disassembled, in order to be able to facilitate the transport of the wheelchair. Apart from this advantage, the conventional wheelchair also has several disadvantages. One important disadvantage of the conventional wheelchair is that the frame and the carrying wheels must be fitted to each other, in order to be able to achieve correct assembly and functioning of the wheelchair. Thus, the frame must be provided with a case or such provision for inclusion of the support part connected to the stator. This means that the frame must always be provided with an adapter to be able to fix the stator, in order to make it possible to transfer the drive torque to the carrying wheel.

While keeping the advantage according to the state of the technique, the invention is intended to create an improved electrical wheelchair, whereby the frame no longer needs to be provided with one or more adapters for fixing the carrying wheels.

For this purpose, the invention provides a wheelchair of the type mentioned in the preamble, characterised in that a stator of the wheel motor is provided with at least one support element for support on the fixed world. Here, the wheel motor can at least be partly fitted in a wheel hub but it is also feasible that the wheel motor is fitted at least partly in the support element or is constructed together with it. Here, such a support is made in another way than via the frame. By letting the stator support directly on the fixed world via the support element, rotation of the stator can be countered (to a certain extent), without a special adaptation of the frame being required. As a result of the mainly fixed state of the stator, the torque supplied by the rotor of the wheel motor can be transferred to the wheel hub and thus to the carrying wheel, which results in rotation of the carrying wheel and thus displacement of the wheelchair. Therefore, a carrying wheel provided with a wheel motor can only be detachably connected via the corresponding insertable axles to generally each frame known in the state of the technique. The carrying wheels can thus be relatively quickly and easily connected to a different type of frame without requiring special measures to adapt the frame, such as the application of an adapter. Such a great degree of flexibility is especially advantageous in case the frame must be (temporarily) replaced by another frame, for example as a consequence of maintenance work and/or with the trial of wheelchairs, whereby the frame can be relatively quickly and easily exchanged with the other frame. A supplementary advantage of the direct support of the stator on the fixed world is that this supplementary support on the fixed world will generally considerably improve the stability of the wheelchair, so that instantaneous and relatively easy tipping (falling over backwards or tilting) of the wheelchair can be prevented, or at least can be countered. Moreover, with the support according to the invention, the carrying wheels can be connected further forward to the frame than is common according to the state of the technique. As a result, the centre of gravity of a user of the wheelchair will become closer to the axis of rotation of the carrying wheels (this means that the plumb line through the centre of gravity of the user will become closer to the centre line through the carrying wheels). This modification makes a simplified handling (manoeuvring) of the wheelchair possible.

In order to be able to displace the wheelchair in the forward direction, the support element preferably support on a position behind the stator, seen from the transport direction. In certain circumstances, it can also be feasible to also let the support element support in front of the stator, seen from the transport direction, in order to be able to stabilise the support of the stator on the fixed world with the transport of the wheelchair both in the forward direction as well as in the backward direction. In a special preferred embodiment, the support element is therefore set for support on the fixed world at several locations, at a distance from each other.

In another preferred embodiment, a turned-away part of the support element of the stator is provided with at least one support wheel. On further consideration, the support wheel is connected swivelling to the support element and is set for support on the wheelchair-carrying base (fixed world). The advantage of applying a support wheel is that, in accordance with the invention, the wheelchair experiences no (or at least relatively little) resistance from the support of the support element on the fixed world during transport of the wheelchair, which improves the efficiency of the drive of the wheelchair in accordance with the invention. Under certain circumstances, it can also be feasible to fix a slide or other sliding element to the support element for support on the fixed world instead of a support wheel.

Preferably, each carrying wheel is provided with a wheel motor included in the wheel hub. Thus, each carrying wheel will be driven by its own wheel motor included in the corresponding wheel hub. In a special preferred embodiment, the wheel motor in the main is fitted completely in the wheel hub. Such a positioning of the wheel motor definitely corresponds with the positioning of the wheel motor in the wheel hub in accordance with the previously discussed Alber patent. The advantage of such a positioning is that a relatively compact construction of carrying wheel and wheel motor can be obtained, which generally considerably facilitates the handling. Each wheel motor will preferably be formed by a DC motor. The energy required for the motor can be supplied by a normal battery/car battery, which is also connected to the support element (for example, assembled as a packet with an arm of the support element) so that no electrical connections need to be made or to be interrupted when a carrying wheel is connected or disconnected.

In a preferred embodiment, the wheel motor is provided with a transmission. Applying a transmission in the wheel motor will lead to an additional driving force on the wheels through instantaneous and progressive multiplication of the torque. Here, the transmission is preferably provided with at least one planetary gearbox, in order to be able to increase the driving force in a relatively easy and efficient way. On further consideration, a two-stage planetary gear drive is applied, with which the torque provided by the rotor of the wheel motor can be transferred to the wheel hub in a relatively easy and efficient way.

In yet another preferred embodiment, the stator is provided with at least one limiting element set for contact on the outside of the frame. Such a limiting element will generally be able to limit and in particular counter undesired rotation of the stator with respect to the frame, particularly during backward displacement. Here, the limiting element can be formed by a projection fitted on the stator, but can also be connected to the support element as a separate element. In a special preferred embodiment, the limiting element is connected swivelling to the support element, whereby forceful means are applied between the limiting element and the support element for the forcing apart of the limiting element and the support element. Here, the forceful means are preferably formed by a gas spring, which provides suspension and damping. For the present, the forceful means can ensure permanent, stable support of the support element on the fixed world during forward displacement of the wheelchair in accordance with the invention. Such a permanent support can be guaranteed during transport over broken terrain. In case, however, the wheelchair is moved in the backward direction in accordance with the invention, the support element will be slightly swivelled towards the frame (lifted up as it were), which can considerably facilitate driving backwards over an obstacle, such as a threshold. As a result of the damping operation of the forceful means, the slight lifting of the support element can be made in a relatively smooth and controlled way.

The wheelchair is preferably provided with a control system for steering the wheel motor. Such a control system usually contains a control, such as a joystick or something similar, and possibly a separately connected control unit. In a special preferred embodiment, the control is positioned at least partly laterally with respect to the frame. Positioning of the control system sideways to the chair unit is relatively favourable, because the user can assume a natural position during the steering or operation of the wheelchair, which can (considerably) prevent or at least can counter fatigue and/or (far-reaching) physical complaints. The control serves particularly as a handle for the user next to the chair unit and can be designed in very diverse ways. Thus, for example, it is feasible to execute the control as a handle, or as a conventional hoop placed next to a carrying wheel. Here, it should also be noted that the hoop does not rotate with the carrying wheels during motorised transport of the wheelchair, but that the hoop is more or less rigidly joined to the insertable axle (and the frame). It is also feasible to integrate the control in an arm support of the wheelchair, so that the natural position of the user can be further stabilised. In a special preferred embodiment, the control system contains two controls positioned at both sides of the chair unit. Thus, it is possible to let two hands operate the drive system. One advantage of this is that both arms of the user are in the main evenly loaded, which can prevent or at least counter physical complaints resulting from overloading an arm, for example. An additional advantage of such a double operation is that the wheelchair can be controlled with relatively high accuracy. Far-reaching details concerning the above-mentioned special operation are described in the not previously published Dutch patent request NL 1023836.

The invention also relates to a carrying wheel provided with a wheel motor for use in such a wheelchair.

The invention will be elucidated on the basis of the non-limitative embodiments shown in the following figures. Here:

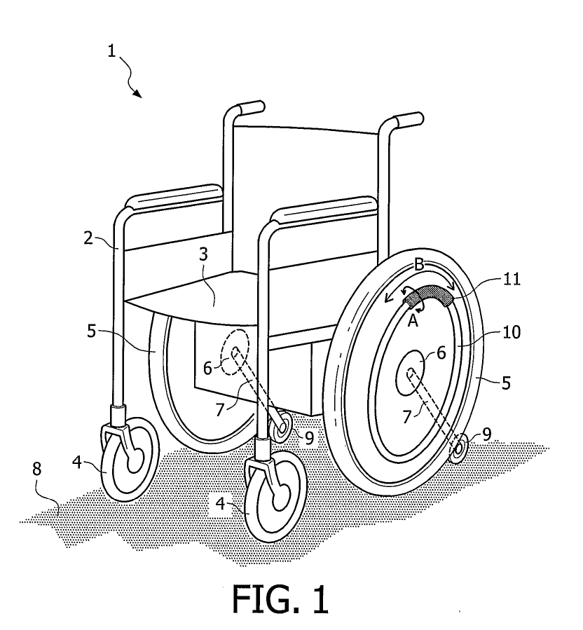

FIG. 1 shows a perspective view of a wheelchair in accordance with the invention,

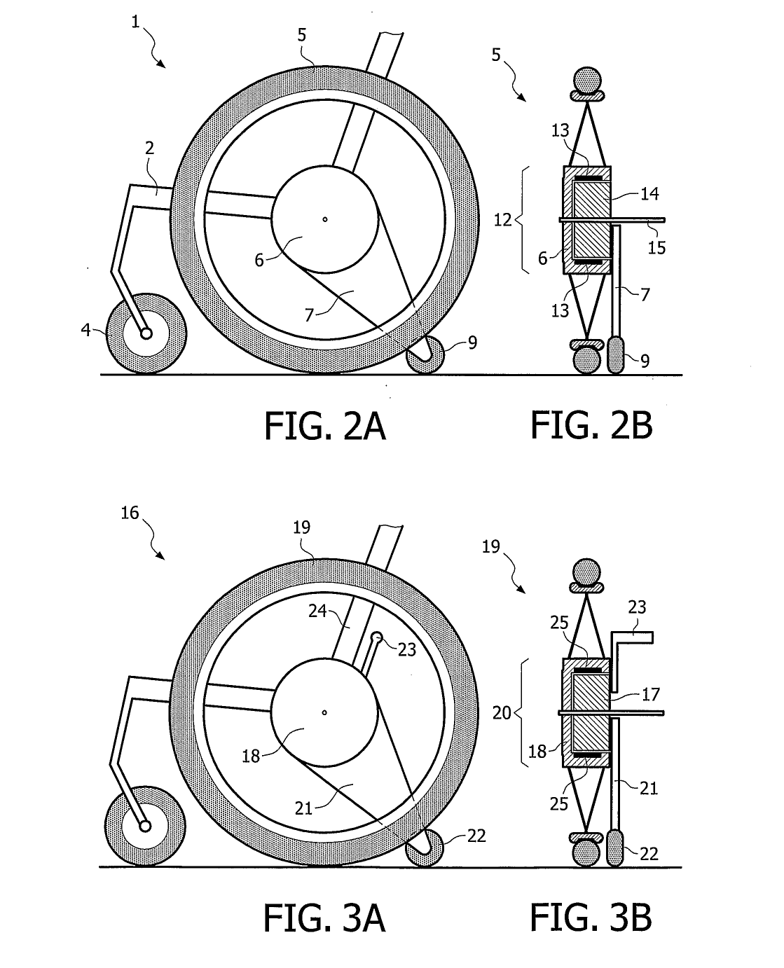

FIG. 2a shows a schematic side view of the wheelchair according to FIG. 1,

FIG. 2b shows a schematic cross-section of a carrying wheel as shown in FIG. 2a,

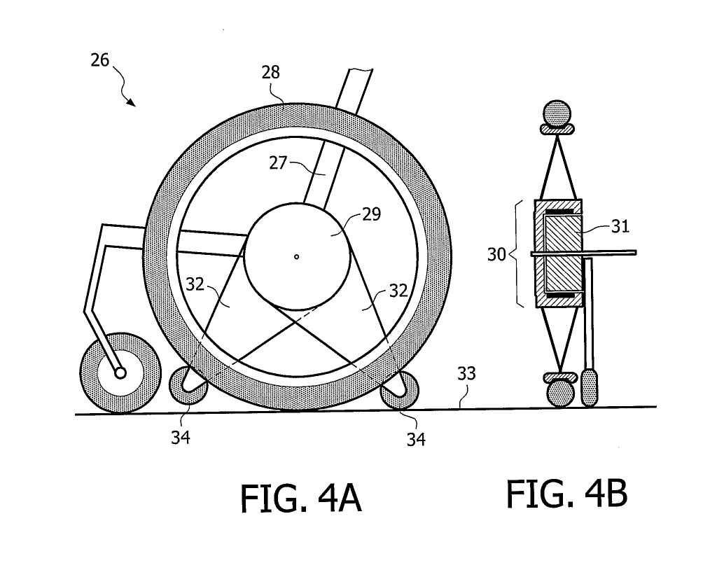

FIG. 3a shows a schematic side view of another wheelchair in accordance with the invention,

FIG. 3b shows a schematic cross-section of a carrying wheel as shown in FIG. 3a,

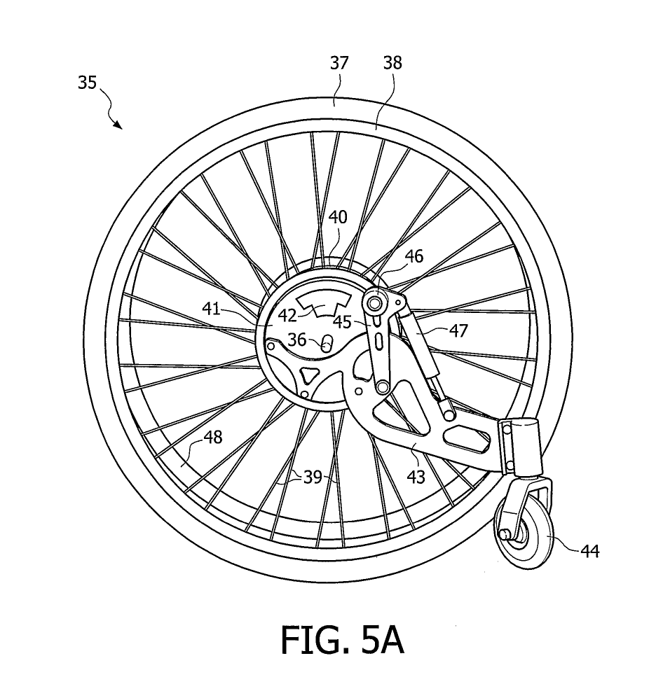

FIG. 4a shows a schematic side view of yet another wheelchair in accordance with the invention,

FIG. 4b shows a schematic cross-section of a carrying wheel as shown in FIG. 4a,

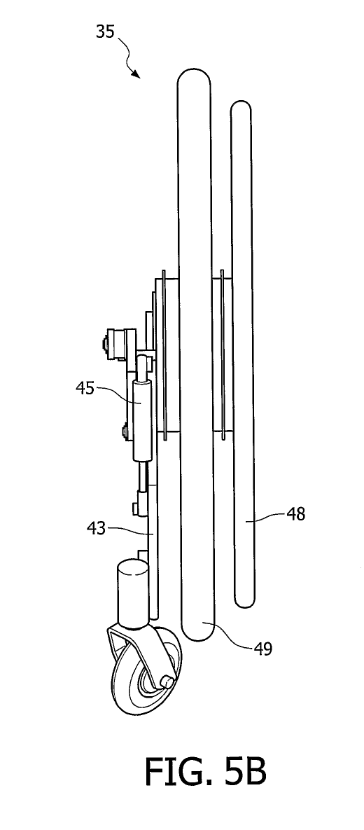

FIG. 5a shows a side view of a preferred embodiment of a carrying Wheel in accordance with the invention, and

FIG. 5b shows a front view of the carrying wheel according to FIG. 5a.

FIG. 1 shows a perspective view of wheelchair 1 in accordance with the invention. Wheelchair 1 contains a frame 2 provided with a chair unit 3. The frame is provided with two small swivel wheels 4 at the front and is detachably connected at the rear to two large carrying wheels 5 oriented along chair unit 3. Here, hub 6 of each carrying wheel 5 is provided with an electromotor, in particular a DC motor (not shown here). The stator of each DC motor is connected to support element 7 (that goes towards the rear) for support on fixed world 8. In order to be able to minimise the resistance during support, each support element 7 is provided with a rotatable support wheel 9 on a turned-away side of the stator. On the turned-away side of frame 2, each carrying wheel 5 is provided with a hoop 10 for the (possible) manual, instead of electrical, displacement of wheelchair 1. Here, hoop 10 is provided with a handle 11 at the top. Handle 11 can be axially rotated (A) and displaced along hoop 10 (B), as indicated by arrows A and B, respectively. By means of handle 11, the electromotor connected to carrying wheel 5 can be controlled. Because handle 11 can be controlled in two directions, a user cannot only regulate the speed of wheelchair 1 by moving handle 11 in direction B, it is also possible to orientate wheelchair 1 in a certain direction by means of the axial rotation of handle 11 in direction A. Thus, wheelchair 1 can be driven with only one hand in a relatively simple, yet effective manner. This can be particularly advantageous for users who are semi-paralysed on one side, for example, or whereby one arm is permanently or temporarily out of use. During forward displacement of wheelchair 1, the stator will support on fixed world 8 under pretension with respect to the mainly fixed frame 2. Here, the torque supplied by the rotor of the electromotor is transferred to hub 6 and thus to carrying wheel 5, which results in rotation of carrying wheel 5 and thus displacement of wheelchair 1. Such a stable support of support element 7 on fixed world 8 also contributes to the stability of wheelchair 1, because relative tipping of wheelchair 1 can be prevented, or at least be made difficult. The advantage of letting the stator support on fixed world 8 via support element 7 and the support wheel 9 is that no special (adaptation to) frame 2, such as a separate adapter (case) et cetera, is required to be able to achieve correct operation of the (electrical) wheelchair 1. It should be noted that support elements 7 as well as the associated support wheels 9 are positioned between the two carrying wheels 5, so that the effective width of wheelchair 1 is not increased with respect to a conventional wheelchair.

FIG. 2a shows a schematic side view of wheelchair 1 according to FIG. 1. FIG. 2a clearly shows that support element 7 goes backwards, away from front swivel wheel 4. FIG. 2b shows a schematic cross-section of carrying wheel 5 according to FIGS. 1 and 2a. FIG. 2b shows the electromotor 12 that is fitted in hub 6 of carrying wheel 5 et cetera. Electromotor 12 contains a hub 6 connected to rotor 13, and a stator 14 included in hub 6. Here, stator 14 is provided with a single-sided protruding insertable axle 15 for the detachable fixture of carrying wheel 5 to frame 2. Usually, electromotor 12 will also be provided with a transmission (not shown here), as described and shown in the previously-discussed Alber patent. As shown, stator 14 is connected to support element 7 and the associated support wheel 9.

FIG. 3a shows a schematic side view of another wheelchair 16 in accordance with the invention. Wheelchair 16 corresponds in the main with wheelchair 1 shown in FIGS. 1-2b, with the difference that stator 17 of an electromotor 20 fitted in hub 18 of carrying wheel 19 is not only provided with a support element 21 provided with a support wheel 22, but also with a limiting element 23 at the top. Limiting element 23 is set to limit the swivelling of support element 21 with a displacement of wheelchair 16 in the backward direction. During such a backward displacement of wheelchair 16, limiting element 23 (and thus stator 17 as well as support element 21) will for the present be moved against the outside of frame 24 of wheelchair 16 connected to carrying wheel 19, after which a torque from electromotor 20 directed at rotor 25 will occur that results in the actual backward displacement of wheelchair 16. As shown in FIG. 3b, the schematic cross-section of carrying wheel 19 clearly shows that the angle-shaped limiting element 23 is rigidly connected to stator 17 at a distance from support element 21.

FIG. 4a shows a schematic side view of yet another wheelchair 26 in accordance with the invention. Here, wheelchair 26 again contains a frame 27 and two drive wheels 28 detachably connected to frame 27 that are positioned along frame 27. Each drive wheel 28 is provided with an electromotor 30 in wheel hub 29 (see FIG. 4b). Here, stator 31 of the electromotor is connected to a two-legged support element 32 set for (simultaneous) double support on fixed world 33. In order to facilitate such a support, support element 32 is provided with two stabilisation wheels 34. Thus, stator 31 can relatively easily and efficiently support on fixed world 33, to thus be able to let wheelchair 26 move in both the forward as well as the backward direction. FIG. 4b shows a schematic cross-section of drive wheel 28 according to FIG. 4a. Because both legs of support element 32 are aligned in this sample embodiment, the currently shown cross-section corresponds with the cross-section shown in FIG. 2b.

FIG. 5a shows a side view of a preferred embodiment of carrying wheel 35 in accordance with the invention. Here, carrying wheel 35 is set to be detachably connected via a central insertable axle 36 to a frame (not shown) of the wheelchair. It should be noted that FIG. 5a shows a view of a side of the wheelchair turned towards the frame. Carrying wheel 35 contains a peripherally oriented rubber band 37, a wheel rim 38, a set of spokes 39, and a centrally placed wheel hub 40 provided with the previously-mentioned insertable axle 36. An electromotor is included in wheel hub 40, of which here only stator 41 is shown. Here, stator 41 is provided with an electrical connector (plug) 42 for the connection of the electromotor to an electrochemical energy source. Stator 41 is rigidly connected to support arm 43 provided with a swivelling and rotatable support wheel 44 set for support on the wheelchair-carrying base. Support arm 43 is connected swivelling to a stop element 45 provided with a protruding (plastic) stud 46 set for contact on the frame. Between support arm 43 and an end of the stop element 45 turned-away from support arm 43, a gas spring 47 is fitted for the forcing apart of support arm 43 and stop element 45. In case carrying wheel 35 is connected to the frame, plastic stud 46 will contact the frame possibly under pretension, whereby gas spring 47 will force support arm 43 in the downward position towards the fixed world. Thus, a stable support of support wheel 44 on the fixed world can be guaranteed both during (forward-directed) transport as well as during standstill, which will increase the stability of the wheelchair for a user. It should be noted that a side of carrying wheel 35 turned-away from support arm 43 is provided with a hoop 48 for the possible manual displacement of the wheelchair. FIG. 5b shows a front view of carrying wheel 35 according to FIG. 5a. FIG. 5b clearly shows that carrying wheel 35 is constructed relatively compactly, whereby hoop 48, the basic construction 49 of carrying wheel 35 as well as the assembly of support arm 43 and stop element 45 are in the main oriented parallel to each other. The relatively compact construction generally benefits the handling of carrying wheel 35, both during (dis)assembly of carrying wheel 35 from or on the frame, respectively, as well as during transport and/or storage of carrying wheel 35.

It should be clear that the invention is not limited to the embodiments shown and described here, but that innumerable variants are possible within the framework of the appended claims, which will be obvious for the person skilled in the art.

1-15. (canceled)

16. A wheelchair, containing:
a frame,
at least two carrying wheels, whereby each carrying wheel is detachably connected to the frame by means of an insertable axle, and
at least one electrical wheel motor for the electrical drive of the carrying wheels, whereby the wheel motor forms part of the detachable carrying wheel,
wherein a stator of the wheel motor is provided with at least one support element for support on the fixed world.

17. The wheelchair according to claim 16, wherein the wheel motor is fitted at least partly in a wheel hub.

18. The wheelchair according to claim 16, wherein the support element is set for contact on the fixed world at a position in front of and/or behind the stator, seen from the transport direction of the wheelchair.

19. The wheelchair according to claim 16, wherein the support element is set for support on the fixed world at several locations, at a distance from each other.

20. The wheelchair according to claim 16, wherein a part of the support element turned-away from the stator is provided with at least one support wheel.

21. The wheelchair according to claim 16, wherein each carrying wheel is provided with a wheel motor included in the wheel hub.

22. The wheelchair according to claim 16, wherein the wheel motor in the main is fitted completely in the wheel hub.

23. The wheelchair according to claim 16, wherein the wheel motor is formed by a DC motor.

24. The wheelchair according to claim 16, wherein the wheel motor is provided with a transmission.

25. The wheelchair according to claim 24, wherein the transmission is provided with a planetary gearbox.

26. The wheelchair according to claim 16, wherein the stator is provided with at least one limiting element set for contact on the outside of the frame.

27. The wheelchair according to claim 26, wherein the limiting element is connected swiveling to the support element, whereby forceful means are applied between the limiting element and the support element for the forcing apart of the limiting element and the support element.

28. The wheelchair according to claim 16, wherein the wheelchair is provided with a control system for controlling the wheel motor.

29. The wheelchair according to claim 28, wherein the control system is provided with a control that is positioned at least partly laterally with respect to the frame.

30. A carrying wheel for use in a wheelchair according to claim 16, comprising at least one electrical wheel motor for the electrical drive of the carrying wheel, wherein a stator of the wheel motor is provided with at least one support element for support on the fixed world.
